(19) United States
(12) Patent Application Publication
(10) Pub. No.: US 2023/0250301 A1
(43) Pub. Date: Aug. 10, 2023

(54) HALOGEN-FREE FLAME RETARDANT POLYMERIC COMPOSITIONS

(71) Applicant: Dow Global Technologies LLC, Midland, MI (US)

(72) Inventors: Krischan Jeltsch, Zuerich (CH); Bharat I. Chaudhary, Princeton, NJ (US); Bhawesh Kumar, Sugar Land, TX (US); Svyatoslav Burmistrov, Moscow (RU); David Lopez Piquer, Tarragona (ES); Camillo Cardelli, Pistoia (IT)

(21) Appl. No.: 18/004,686

(22) PCT Filed: Oct. 25, 2021
(86) PCT No.: PCT/US2021/056459

§ 371 Date: Jan. 9, 2023

(30) Foreign Application Priority Data
Oct. 28, 2020 (IT) 102020000025531

(51) Int. Cl. C09D 5/18; C09D 123/06; C09D 7/61; H01B 3/44; H01B 7/295

(52) U.S. Cl. CPC C09D 5/18; C09D 123/06; C09D 7/61; H01B 3/441; H01B 7/295

(57) ABSTRACT

A polymeric composition includes a first ethylene-based polymer having a crystallinity at 110° C. of 25 wt % or greater as measured according to Crystallinity Testing; a second ethylene-based polymer having a crystallinity at 23° C. of 40 wt % or less as measured according to Crystallinity Testing; and 40 wt % or greater of a halogen-free flame retardant filler.

### BACKGROUND

### Field of the invention

The present disclosure generally relates to polymeric compositions and more specifically to polymeric compositions including mineral fillers such as metal hydrates and metal carbonates.

### Introduction

Polyolefin based halogen-free flame retardant (“HFFR”) cable jacket compositions are useful for a variety of applications where flame retardancy of the insulation/jacketing material is important. Flame retardancy is often achieved through the addition of mineral fillers that dilute the concentration of flammable polymer material and decompose below the degradation temperature of the polymer when exposed to heat. The decomposition of the metal hydrates releases water thereby removing heat from the fire source, and the decomposition of metal carbonates produces carbon dioxide which acts as a gas/vapor phase diluent. Traditional HFFR cable jacket compositions are used indoors, in buildings, trains, cars, or wherever people may be present. In many instances, the polyolefin (or olefinic polymer) is an ethylene-based polymer.

The use of mineral fillers in polyolefin wire and cable formulations suffers from a number of drawbacks, the majority of which stem from the relatively high level of filler necessary to meet fire retardant specifications. Filler loadings of 40 weight percent (wt %) or greater in polyolefins are not uncommon. This loading of filler affects HFFR cable jacket composition properties and leads to compounds with a high density, limited flexibility and decreased mechanical properties such as tensile elongation at break.

Blends of amorphous or low crystallinity olefinic polymers often must be used to allow incorporation of such high filler loadings. Low crystallinity at room temperature (i.e., 23° C.) has been seen as advantageous in increasing filler loading as crystalline regions in polymers are unable to accept filler. As such, olefinic polymers allow for greater filler loading levels as the crystalline fraction decreases (and amorphous fraction increases). Although accommodating a high filler loading, thereby yielding high values of tensile elongation at break, olefinic polymers with high amorphous fractions typically yield lower resistance to mechanical deformation and fail traditional tests for HFFR cable jackets such as “hot pressure” or “hot knife” indentation tests as governed by IEC 60811-508. In essence, there is a tradeoff between the hardness (modulus) of an olefinic polymer due to crystallinity and the maximum filler loading the polymer can achieve. To overcome the low resistance to mechanical deformation, cross-linking of the olefinic polymers may be performed to enhance the cable jackets mechanical properties, but this generally has a deleterious effect on tensile elongation at break.

In view of the foregoing, it would be surprising to discover a polymeric composition having a HFFR content of 40 wt % or greater and an ethylene-based polymer with a crystallinity at 110° C. of 25 wt % or greater that exhibits a hot knife indentation of less than 50% as measured according to IEC 60811-508 and a tensile elongation at break of 100% or greater at 23° C. as measured according to ASTM D638.

### SUMMARY OF THE INVENTION

The present invention offers a polymeric composition having a HFFR content of 40 wt % or greater and an ethylene-based polymer with a crystallinity at 110° C. of 25 wt % or greater that exhibits a hot knife indentation of less than 50% as measured according to IEC 60811-508 and a tensile elongation at break of 100% or greater at 23° C. as measured according to ASTM D638.

The present invention is a result of discovering that by utilizing polymers that retain a crystallinity of 25 wt % or greater at 110° C., the polymeric composition is effectively hardened to pass the hot knife test while not unnecessarily decreasing the maximum filler content of the polymeric composition to retain sufficiently high tensile elongation at break at 23° C. The crystallinity of a polymer generally decreases with increasing temperature, but the rate of decrease in crystallinity per unit of temperature is different for different polymers. For conventionally used polymers, not only does the polymer become softer at elevated temperatures due to loss of crystallinity, but also the filler acceptance capability (which affects total filler loading while retaining sufficiently high tensile elongation at break at 23° C.) is negatively impacted by the high crystallinity at 23° C. In essence, filler acceptance capability (and therefore total filler loading) is decreased due to crystallinity that ultimately does not aid in passing the hot knife test. This relationship was unrecognized by the prior art because it generally focused on crystallinity at room temperature. In contrast, the present invention's use of a polymer that retains a crystallinity of 25 wt % or greater at 110° C. not only makes the polymeric composition hard enough to pass the hot knife test, but it is also able to incorporate a HFFR content of 40 wt % or greater, while retaining sufficiently high tensile elongation at break at 23° C. Surprisingly, it has been discovered that 25 wt % or greater crystallinity at 110° C. is sufficient to pass the hot knife test.

The present invention is particularly useful for use in coated conductors.

According to a first feature of the present disclosure, a polymeric composition comprises a first ethylene-based polymer having a crystallinity at 110° C. of 25 wt % or greater as measured according to Crystallinity Testing; a second ethylene-based polymer having a crystallinity at 23° C. of 40 wt % or less as measured according to Crystallinity Testing; and 40 wt % or greater of a halogen-free flame retardant filler.

According to a second feature of the present disclosure, the halogen-free flame retardant filler is magnesium hydroxide.

According to a third feature of the present disclosure, the polymeric composition comprises from 40 wt % to 65 wt % of magnesium hydroxide based on the total weight of the polymeric composition.

According to a fourth feature of the present disclosure, the polymeric composition comprises from 5 wt % to 40 wt % of the second ethylene-based polymer based on the total weight of the polymeric composition.

According to a fifth feature of the present disclosure, the polymeric composition comprises from 5 wt % to 40 wt % of the first ethylene-based polymer based on the total weight of the polymeric composition.

According to a sixth feature of the present disclosure, the first ethylene-based polymer has a density of 0.925 g/cc to 0.950 g/cc.

According to a seventh feature of the present disclosure, the first ethylene-based polymer comprises a low-density component having a density in the range from 0.910 g/cc to 0.935 g/cc as measured according to ASTM D792.

According to an eighth first feature of the present disclosure, the first ethylene-based polymer comprises a high-density component having a density in the range from 0.945 g/cc to 0.965 g/cc as measured according to ASTM D792.

According to a ninth feature of the present disclosure, the first ethylene-based polymer has an Oxidative Induction Time at 200° C. of 20 minutes or greater as measured according to ASTM D3895.

According to a tenth feature of the present disclosure, a coated conductor comprises a conductor and the polymeric composition disposed at least partially around the conductor.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number.

References to test methods contain both a reference to the testing society and the test method number. Test method organizations are referenced by one of the following abbreviations: ASTM refers to ASTM International (formerly known as American Society for Testing and Materials); IEC refers to International Electrotechnical Commission; EN refers to European Norm; DIN refers to Deutsches Institut fur Normung; and ISO refers to International Organization for Standards.

As used herein, the term weight percent (“wt %”) designates the percentage by weight a component is of a total weight of the polymeric composition unless otherwise specified.

Melt index (I₂) values herein refer to values determined according to ASTM method D1238 at 190 degrees Celsius (° C.) with 2.16 Kilogram (Kg) mass and are provided in units of grams eluted per ten minutes (“g/10 min”).

Density values herein refer to values determined according to ASTM D792 at 23° C. and are provided in units of grams per cubic centimeter (“g/cc”).

As used herein, Chemical Abstract Services registration numbers (“CAS#”) refer to the unique numeric identifier as most recently assigned as of the priority date of this document to a chemical compound by the Chemical Abstracts Service.

### Polymeric Composition

The present disclosure is directed to a polymeric composition. The polymeric composition comprises a first ethylene-based polymer, a second ethylene-based polymer, and a halogen-free flame retardant filler.

### Ethylene-Based Polymers

As noted above, the polymeric composition includes the first ethylene-based polymer and the second ethylene-based polymer. As used herein, “ethylene-based polymers” are polymers in which greater than 50 wt % of the monomers are ethylene though other co-monomers may also be employed. “Polymer” means a macromolecular compound comprising a plurality of monomers of the same or different type which are bonded together, and includes homopolymers and interpolymers. “Interpolymer” means a polymer comprising at least two different monomer types bonded together. Interpolymer includes copolymers (usually employed to refer to polymers prepared from two different monomer types), and polymers prepared from more than two different monomer types (e.g., terpolymers (three different monomer types) and quaterpolymers (four different monomer types)). The ethylene-based polymer can be an ethylene homopolymer. As used herein, “homopolymer” denotes a polymer comprising repeating units derived from a single monomer type, but does not exclude residual amounts of other components used in preparing the homopolymer, such as catalysts, initiators, solvents, and chain transfer agents.

Ethylene-based polymers may comprise 50 wt % or greater, 60 wt % or greater, 70 wt % or greater, 80 wt % or greater, 85 wt % or greater, 90 wt % or greater, or 91 wt % or greater, or 92 wt % or greater, or 93 wt % or greater, or 94 wt % or greater, or 95 wt % or greater, or 96 wt % or greater, or 97 wt % or greater, or 97.5 wt % or greater, or 98 wt % or greater, or 99 wt % or greater, while at the same time, 100 wt % or less, 99.5 wt % or less, or 99 wt % or less, or 98 wt % or less, or 97 wt % or less, or 96 wt % or less, or 95 wt % or less, or 94 wt % or less, or 93 wt % or less, or 92 wt % or less, or 91 wt % or less, or 90 wt % or less, or 85 wt % or less, or 80 wt % or less, or 70 wt % or less, or 60 wt % or less of ethylene as measured using Nuclear Magnetic Resonance (NMR) or Fourier-Transform Infrared (FTIR) Spectroscopy. Nonlimiting examples of suitable ethylene-based polymers include ethylene/alpha-olefin (α-olefin) copolymer, ethylene/C₃-C₈ alpha-olefin copolymer, ethylene/C₄-C₈ alpha-olefin copolymer, and copolymers of ethylene and one or more of the following comonomers: acrylate, (meth)acrylic acid, (meth)acrylic ester, carbon monoxide, maleic anhydride, vinyl acetate, vinyl propionate, mono esters of maleic acid, diesters of maleic acid, vinyl trialkoxysilane, vinyl trialkyl silane, and any combination thereof. Suitable ethylene-based polymers also include those in which these comonomers are grafted to ethylene-based polymers. Other units of ethylene-based polymers may include C₃, or C₄, or C₆, or C₈, or C₁₀, or C₁₂, or C₁₆, or C₁₈, or C₂₀ α-olefins, such as propylene, 1-butene, 1-hexene, 4-methyl- 1-pentene, and 1-octene.

Ethylene-based polymers can have a unimodal or a multimodal molecular weight distribution and can be used alone or in combination with one or more other types of ethylene-based polymers (e.g., a blend of two or more ethylene-based polymers that differ from one another by monomer composition and content, catalytic method of preparation, molecular weight, molecular weight distributions, densities, etc.). If a blend of ethylene-based polymers is employed, the polymers can be blended by any in-reactor or post-reactor process.

The polymeric composition includes a first ethylene-based polymer and a second ethylene-based polymer. The first and second ethylene-based polymers used in the polymeric composition may differ from one another in density, melt flow index, chemical constituency, molecular weight distribution, crystallinity at different temperatures and oxidative induction times.

### First Ethylene-Based Polymer

The first ethylene-based polymer may have a density of 0.925 g/cc to 0.950 g/cc. For example, the density of the first ethylene-based polymer may be 0.925 g/cc or greater, or 0.930 g/cc or greater, or 0.935 g/cc or greater, or 0.940 g/cc or greater, or 0.945 g/cc or greater, while at the same time, 0.950 g/cc or less, or 0.945 g/cc or less, or 0.940 g/cc or less, or 0.935 g/cc or less, or 0.930 g/cc or less.

The first ethylene-based polymer may have a melt index of 0.1 g/10 min. to 5 g/10 min. For example, the melt index of the first ethylene-based polymer may be 0.1 g/10 min. or greater, or 0.5 g/10 min. or greater, or 1.0 g/10 min. or greater, or 1.5 g/10 min. or greater, or 2.0 g/10 min. or greater, or 2.5 g/10 min. or greater, or 3.0 g/10 min. or greater, or 3.5 g/10 min. or greater, or 4.0 g/10 min. or greater, or 4.5 g/10 min. or greater, while at the same time, 5.0 g/10 min. or less, or 4.5 g/10 min. or less, or 4.0 g/10 min. or less, or 3.5 g/10 min. or less, or 3.0 g/10 min. or less, or 2.5 g/10 min. or less, or 2.0 g/10 min. or less, or 1.5 g/10 min. or less, or 1.0 g/10 min. or less, or 0.5 g/10 min. or less. The melt index is measured in accordance with ASTM D1238 at 190° C. and 2.16 kg.

In a multimodal specific example, the first ethylene-based polymer comprises a high molecular weight (“low density”) component and a low molecular weight (“high density”) component.

The low-density component of the ethylene-based polymer may have a density of 0.910 g/cc to 0.935 g/cc. For example, the density of the low-density component of the first ethylene-based polymer may be 0.910 g/cc or greater, or 0.915 g/cc or greater, or 0.920 g/cc or greater, or 0.925 g/cc or greater, or 0.930 g/cc or greater, while at the same time, 0.935 g/cc or less, or 0.930 g/cc or less, or 0.925 g/cc or less, or 0.920 g/cc or less, or 0.915 g/cc or less.

The low-density component of the first ethylene-based polymer may have a melt index of 0.1 g/10 min. to 1.0 g/10 min. For example, the melt index of the low-density component may be 0.01 g/10 min. or greater, or 0.1 g/10 min. or greater, or 0.2 g/10 min. or greater, or 0.3 g/10 min. or greater, or 0.4 g/10 min. or greater, or 0.5 g/10 min. or greater, or 0.6 g/10 min. or greater, or 0.7 g/10 min. or greater, or 0.8 g/10 min. or greater, or 0.9 g/10 min. or greater, while at the same time, 1.0 g/10 min. or less, or 0.9 g/10 min. or less, or 0.8 g/10 min. or less, or 0.7 g/10 min. or less, or 0.6 g/10 min. or less, or 0.5 g/10 min. or less, or 0.4 g/10 min. or less, or 0.3 g/10 min. or less, or 0.2 g/10 min. or less, or 0.1 g/10 min. or less. The melt index is measured in accordance with ASTM D1238 at 190° C. and 2.16 kg.

The high-density component of the first ethylene-based polymer may have a density of 0.945 g/cc to 0.965 g/cc. For example, the density of the high-density component of the first ethylene-based polymer may be 0.945 g/cc or greater, or 0.950 g/cc or greater, or 0.955 g/cc or greater, or 0.960 g/cc or greater, while at the same time, 0.965 g/cc or less, or 0.960 g/cc or less, or 0.955 g/cc or less, or 0.950 g/cc or less.

The high-density component of the first ethylene-based polymer may have a melt index of 2.0 g/10 min. to 200 g/10 min. For example, the melt index of the high-density component may be 2.0 g/10 min. or greater, or 10 g/10 min. or greater, or 20 g/10 min. or greater, or 50 g/10 min. or greater, or 100 g/10 min. or greater, or 150 g/10 min. or greater, while at the same time, 200 g/10 min. or less, or 150 g/10 min. or less, or 100 g/10 min. or less, or 50 g/10 min. or less, or 20 g/10 min. or less, or 10 g/10 min. or less, or 5 g/10 min. or less. The melt index is measured in accordance with ASTM D1238 at 190° C. and 2.16 kg.

The first ethylene-based polymer has a crystallinity at 110° C. of 25 wt % or greater as measured according to Crystallinity Testing. Crystallinity Testing is defined in detail below in the Examples section. The first ethylene-based polymer may have a crystallinity at 110° C. of 25 wt % 30 or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, while at the same time, 70 wt % or less, or 65 wt % or less, or 60 wt % or less, or 55 wt % or less, or 50 wt % or less, or 45 wt % or less, or 40 wt % or less, or 35 wt % or less, or 30 wt % or less as measured according to Crystallinity Testing. The first ethylene-based polymer may have a crystallinity at 23° C. of from 40 wt % to 70 wt % as measured according to Crystallinity Testing. For example, the first ethylene-based polymer may have a crystallinity at 23° C. of 40 wt % or greater, or 45 wt % or greater, or 50 wt % or greater, or 55 wt % or greater, or 60 wt % or greater, or 65 wt % or greater, while at the same time, 70 wt % or less, or 65 wt % or less, or 60 wt % or less, or 55 wt % or less, or 50 wt % or less, or 45 wt % or less as measured according to Crystallinity Testing.

The first ethylene-based polymer has an Oxidative Induction Time (“OTT”) at 200° C. of 20 minutes or greater as measured according to ASTM D3895. For example, the first ethylene-based polymer may have an Oxidative Induction Time at 200° C. of 20 minutes or greater, or 30 minutes or greater, or 40 minutes or greater, or 50 minutes or greater, or 60 minutes or greater, or 70 minutes or greater, or 80 minutes or greater, or 90 minutes or greater, or 100 minutes or greater, or 110 minutes or greater, or 120 minutes or greater, or 130 minutes or greater, or 140 minutes or 15 greater, or 150 minutes or greater, while at the same time, 160 minutes or less, or 150 minutes or less, or 140 minutes or less, or 130 minutes or less, or 120 minutes or less, or 110 minutes or less, or 100 minutes or less, or 90 minutes or less, or 80 minutes or less, or 70 minutes or less, or 60 minutes or less as measured according to ASTM D3895. It is believed that the increased OTT at 200° C. values beneficially resists degradation of the polymeric composition's modulus after heat exposure thereby allowing better performance in the hot knife test.

The polymeric composition may comprise 5 wt % or greater, or 10 wt % or greater, or 15 wt % or greater, or 20 wt % or greater, or 25 wt % or greater, or 30 wt % or greater, or 35 wt % or greater, while at the same time, 40 wt % or less, or 35 wt % or less, or 30 wt % or less, or 25 wt % or less, or 20 wt % or less, or 15 wt % or less, or 10 wt % or less, of the first ethylene-based polymer based on the total weight of the polymeric composition.

### Second EthyleneBbased Polymer

The second ethylene-based polymer may have a density of 0.860 g/cc or greater, or 0.865 g/cc or greater, or 0.870 g/cc or greater, or 0.880 g/cc or greater, or 0.885 g/cc or greater, or 0.890 g/cc or greater, or 0.900 g/cc or greater, or 0.910 g/cc or greater, or 0.920 g/cc or greater, while at the same time, 1.000 g/cc or less, or 0.990 g/cc or less, or 0.980 g/cc or less, or 0.970 g/cc or less, or 0.960 g/cc or less, or 0.950 g/cc or less, or 0.940 g/cc or less, or 0.930 g/cc or less, or 0.920 g/cc or less, or 0.910 g/cc or less, or 0.900 g/cc or less, or 0.890 g/cc or less, or 0.880 g/cc or less , or 0.870 g/cc or less as measured according to ASTM D792.

The second ethylene-based polymer may have a melt index of 1 g/10 min. or greater, or 2 g/10 min. or greater, 3 g/10 min. or greater, 4 g/10 min. or greater, 5 g/10 min. or greater, 6 g/10 min. or greater, 7 g/10 min. or greater, 8 g/10 min. or greater, 9 g/10 min. or greater, 10 g/10 min. or greater, or 11 g/10 min. or greater, or 12 g/10 min. or greater, 13 g/10 min. or greater, 14 g/10 min. or greater, 15 g/10 min. or greater, 16 g/10 min. or greater, 17 g/10 min. or greater, 18 g/10 min. or greater, 19 g/10 min. or greater, while at the same time, 20 g/10 min. or less, or 19 g/10 min. or less, or 18 g/10 min. or less, or 17 g/10 min. or less, or 16 g/10 min. or less, or 15 g/10 min. or less, or 14 g/10 min. or less, or 13 g/10 min. or less, or 12 g/10 min. or less, or 11 g/10 min. or less, or 10 g/10 min. or less, or 9 g/10 min. or less, or 8 g/10 min. or less, or 7 g/10 min. or less, or 6 g/10 min. or less, or 5 g/10 min. or less, or 4 g/10 min. or less, or 3 g/10 min. or less, or 2 g/10 min. or less. The melt index is measured in accordance with ASTM D1238 at 190° C. and 2.16 kg.

The second ethylene-based polymer has a crystallinity at 23° C. of 40 wt % or less as measured according to Crystallinity Testing. For example, the second ethylene-based polymer may have a crystallinity at 23° C. of 40 wt % or less, or 35 wt % or less, or 30 wt % or less, or 25 wt % or less, or 20 wt % or less, or 15 wt % or less, or 10 wt % or less, or 5 wt % or less, or 0 wt %, while at the same time, 1 wt % or greater, or 5 wt % or greater, or 10 wt % or greater, or 15 wt % or greater, or 20 wt % or greater, or 25 wt % or greater, or 30 wt % or greater, or 35 wt % or greater as measured according to Crystallinity Testing.

The polymeric composition may comprise 5 wt % or greater, or 10 wt % or greater, or 15 wt % or greater, or 20 wt % or greater, or 25 wt % or greater, or 30 wt % or greater, or 35 wt % or greater, while at the same time, 40 wt % or less, or 35 wt % or less, or 30 wt % or less, or 25 wt % or less, or 20 wt % or less, or 15 wt % or less, or 10 wt % or less of the second ethylene-based polymer based on the total weight of the polymeric composition.

In some examples, the polymeric composition may comprise a second ethylene-based polymer that is a copolymer of ethylene and one or more of the comonomers (copolymerized or grafted) selected from the group consisting of acrylate, (meth)acrylic acid, (meth)acrylic ester, carbon monoxide, maleic anhydride, vinyl acetate, vinyl propionate, mono esters of maleic acid, diesters of maleic acid, vinyl trialkoxysilane, vinyl trialkyl silane, and combinations thereof. The polymeric composition may such examples of the second ethylene-based polymer in concentrations of 0 wt % or greater, or 1 wt % or greater, or 2 wt % or greater, or 3 wt % or greater, or 4 wt % or greater, or 5 wt % or greater, or 6 wt % or greater, or 7 wt % or greater, or 8 wt % or greater, or 9 wt % or greater, or 10 wt % or greater, or 15 wt % or greater, or 20 wt % or greater, or 25 wt % or greater, while at the same time, 30 wt % or less, or 25 wt % or less, or 20 wt % or less, or 15 wt % or less, or 10 wt % or less, or 9 wt % or less, or 8 wt % or less, or 7 wt % or less, or 6 wt % or less, or 5 wt % or less, or 4 wt % or less, or 3 wt % or less, or 2 wt % or less, or 1 wt % or less based on the total weight of the polymeric composition.

In some examples, the polymeric composition may comprise a maleated second ethylene-based polymer. As used herein, the term “maleated” indicates an ethylene-based polymer that has been modified to incorporate a maleic anhydride monomer. Maleated ethylene-based polymers can be formed by copolymerization of maleic anhydride monomer with ethylene and other monomers (if present) to prepare an interpolymer having maleic anhydride incorporated into the polymer backbone. Additionally or alternatively, the maleic anhydride can be graft-polymerized to the ethylene-based polymer. Maleated examples of the second ethylene-based polymer may be useful in functioning as a compatibilizer between the ethylene-based polymers of the polymeric composition and the HFFR.

The maleated second ethylene-based polymer can have a maleic anhydride content, based on the total weight of the maleated second ethylene-based polymer, of 0.25 wt % or greater, or 0.50 wt % or greater, or 0.75 wt % or greater, or 1.00 wt % or greater, or 1.25 wt % or greater, or 1.50 wt % or greater, or 1.75 wt % or greater, or 2.00 wt % or greater, or 2.25 wt % or greater, or 2.50 wt % or greater, or 2.75 wt % or greater, while at the same time, 3.00 wt % or less, or 2.75 wt % or less, or 2.50 wt % or less, or 2.25 wt % or less, or 2.00 wt % or less, or 1.75 wt % or less, or 1.50 wt % or less, or 1.25 wt % or less, or 1.00 wt % or less, or 0.75 wt % or less, or 0.5 wt % or less. Maleic anhydride concentrations are determined by Titration Analysis. Titration Analysis is performed by utilizing dried resin and titrates with 0.02N KOH to determine the amount of maleic anhydride. The dried polymers are titrated by dissolving 0.3 to 0.5 grams of maleated polymer in about 150 mL of refluxing xylene. Upon complete dissolution, deionized water (four drops) is added to the solution and the solution is refluxed for 1 hour. Next, 1% thymol blue (a few drops) is added to the solution and the solution is over titrated with 0.02N KOH in ethanol as indicated by the formation of a purple color. The solution is then back-titrated to a yellow endpoint with 0.05N HCl in isopropanol.

The polymeric composition may comprise 0 wt % or greater, or 1 wt % or greater, or 2 wt % or greater, or 3 wt % or greater, or 4 wt % or greater, or 5 wt % or greater, or 6 wt % or greater, or 7 wt % or greater, or 8 wt % or greater, or 9 wt % or greater, while at the same time, 10 wt % or less, or 9 wt % or less, or 8 wt % or less, or 7 wt % or less, or 6 wt % or less, or 5 wt % or less, or 4 wt % or less, or 3 wt % or less, or 2 wt % or less, or 1 wt % or less of the maleated second ethylene-based polymer based on the total weight of the polymeric composition.

### Halogen-Free Flame Retardant Filler

The halogen-free flame retardant of the polymeric composition can inhibit, suppress, or delay the production of flames. Examples of the halogen-free flame retardants suitable for use in the polymeric composition include, but are not limited to, metal hydrates, metal carbonates, red phosphorous, silica, alumina, aluminum hydroxide, magnesium hydroxide, titanium oxide, carbon nanotubes, talc, clay, organo-modified clay, calcium carbonate, zinc borate, antimony trioxide, wollastonite, mica, ammonium octamolybdate, frits, hollow glass microspheres, intumescent compounds, expanded graphite, and combinations thereof. In an embodiment, the halogen-free flame retardant can be selected from the group consisting of aluminum hydroxide, magnesium hydroxide, calcium carbonate, and combinations thereof. The halogen-free flame retardant can optionally be surface treated (coated) with a saturated or unsaturated carboxylic acid having 8 to 24 carbon atoms, or 12 to 18 carbon atoms, or a metal salt of the acid. Exemplary surface treatments are described in U.S. Pat. Nos. 4,255,303, 5,034,442, 7,514,489, US 2008/0251273, and WO 2013/116283. Alternatively, the acid or salt can be merely added to the composition in like amounts rather than using the surface treatment procedure. Other surface treatments known in the art may also be used including silanes, titanates, phosphates and zirconates.

Commercially available examples of halogen-free flame retardants suitable for use in compositions according to this disclosure include, but are not limited to, APYRAL™ 40CD aluminum hydroxide available from Nabaltec AG, MAGNIFIN™ H5 magnesium hydroxide available from Magnifin Magnesiaprodukte GmbH & Co KG, Microcarb 95T ultramicronized and treated calcium carbonate available from Reverte, and combinations thereof.

The polymeric composition may comprise HFFR filler in an concentration of 40 wt % or greater, or 42 wt % or greater, or 44 wt % or greater, or 46 wt % or greater, or 48% or greater, or 50 wt % or greater, or 52 wt % or greater, or 54 wt % or greater, or 56 wt % or greater, or 58% or greater, or 60 wt % or greater, or 62 wt % or greater, or 64 wt % or greater, or 66 wt % or greater, or 68% or greater, or 70 wt % or greater, or 72 wt % or greater, or 74 wt % or greater, or 76 wt % or greater, or 78% or greater, while at the same time, 80 wt % or less, or 78 wt % or less, or 76 wt % or less, or 74 wt % or less, or 72 wt % or less, or 70 wt % or less, or 68 wt % or less, or 66 wt % or less, or 64 wt % or less, or 62 wt % or less, or 60 wt % or less, or 58 wt % or less, or 56 wt % or less, or 54 wt % or less, or 52 wt % or less, or 50 wt % or less, or 48 wt % or less, or 46 wt % or less, or 44 wt % or less, or 42 wt % or less based on the weight of the polymeric composition.

### Additives

The polymeric composition may comprise additional additives in the form of antioxidants, cross-linking co-agents, cure boosters and scorch retardants, processing aids, coupling agents, ultraviolet stabilizers (including UV absorbers), antistatic agents, additional nucleating agents, slip agents, lubricants, viscosity control agents, tackifiers, anti-blocking agents, surfactants, extender oils, acid scavengers, flame retardants, anti-drip agents (e.g., ethylene vinyl acetate) and metal deactivators. The polymeric composition may comprise from 0.01 wt % to 20 wt % of one or more of the additional additives.

The UV light stabilizers may comprise hindered amine light stabilizers (“HALS”) and UV light absorber (“UVA”) additives. Representative UVA additives include benzotriazole types such as TINUVIN 326™ light stabilizer and TINUVIN 328™ light stabilizer commercially available from Ciba, Inc. Blends of HAL's and UVA additives are also effective.

The antioxidants may comprise hindered phenols such as tetrakis[methylene(3,5-di-tert-butyl-4-hydroxyhydro-cinnamate)] methane; bis[beta-(3,5-ditert-butyl-4-hydroxybenzyl) methylcarboxyethyl)]-sulphide, 4,4′-thiobis(2-methyl-6-tert-butylphenol), 4,4′-thiobis(2-tert-butyl-5-methylphenol), 2,2′-thiobis(4-methyl-6-tert-butylphenol), and thiodiethylene bis(3,5-di-tert-butyl-4-hydroxy)-hydrocinnamate; phosphites and phosphonites such as tris(2,4-di-tert-butylphenyl)phosphite and di-tert-butylphenyl-phosphonite; thio compounds such as dilaurylthiodipropionate, dimyristylthiodipropionate, and distearylthiodipropionate; various siloxanes; polymerized 2,2,4-trimethyl-1,2-dihydroquinoline, n,n′-bis(1,4-dimethylpentyl-p-phenylenediamine), alkylated diphenylamines, 4,4′-bis(alpha, alpha-dimethylbenzyl)diphenylamine, diphenyl-p-phenylenediamine, mixed di-aryl-p-phenylenediamines, and other hindered amine anti-degradants or stabilizers. 5 The processing aids may comprise metal salts of carboxylic acids such as zinc stearate or calcium stearate; fatty acids such as stearic acid, oleic acid, or erucic acid; fatty amides such as stearamide, oleamide, erucamide, or N,N′-ethylene bis-stearamide; polyethylene wax; oxidized polyethylene wax; polymers of ethylene oxide; copolymers of ethylene oxide and propylene oxide; vegetable waxes; petroleum waxes; non-ionic surfactants; silicone fluids and polysiloxanes.

### Compounding and Coated Conductor Formation

The components of the polymeric composition can be added to a batch or continuous mixer for melt blending to form a melt-blended composition. The components can be added in any order or first preparing one or more masterbatches for blending with the other components. The melt blending may be conducted at a temperature above the melting point of the highest melting polymer. The melt-blended composition is then delivered to an extruder or an injection-molding machine or passed through a die for shaping into the desired article, or converted to pellets, tape, strip or film or some other form for storage or to prepare the material for feeding to a next shaping or processing step. Optionally, if shaped into pellets or some similar configuration, then the pellets, etc. can be coated with an anti-block agent to facilitate handling while in storage.

Examples of compounding equipment used include internal batch mixers, such as a BANBURY™ or BOLLING™ internal mixer. Alternatively, continuous single, or twin screw, mixers can be used, such as FARRELL™ continuous mixer, a WERNER™ and PFLEIDERER™ twin screw mixer, or a BUSS TM kneading continuous extruder. The type of mixer utilized, and the operating conditions of the mixer, will affect properties of the composition such as viscosity, volume resistivity, and extruded surface smoothness.

A coated conductor may be made from the polymeric composition. The coated conductor includes a conductor and a coating. The coating including the polymeric composition. The polymeric composition is at least partially disposed around the conductor to produce the coated conductor. The conductor may comprise a conductive metal or an optically transparent structure.

The process for producing a coated conductor includes mixing and heating the polymeric composition to at least the melting temperature of the polymeric components in an extruder to form a polymeric melt blend, and then coating the polymeric melt blend onto the conductor. The term “onto” includes direct contact or indirect contact between the polymeric melt blend and the conductor. The polymeric melt blend is in an extrudable state.

The polymeric composition is disposed around on and/or around the conductor to form a coating. The coating may be one or more inner layers such as an insulating layer. The coating may wholly or partially cover or otherwise surround or encase the conductor. The coating may be the sole component surrounding the conductor. Alternatively, the coating may be one layer of a multilayer jacket or sheath encasing the conductor. The coating may directly contact the conductor. The coating may directly contact an insulation layer surrounding the conductor.

### EXAMPLES

### Materials

The following materials are employed in the Examples, below.

2EP(A) is an ethylene-based polymer having an octene comonomer and exhibiting a density of 0.885 g/cc, a melt index of 1.0 g/10 min., a crystallinity of 23 wt % at 23° C. and is commercially available from The Dow Chemical Company, Midland, Mich.

2EP(B) is an ethylene-based polymer having a butene comonomer and exhibiting a density of 0.865 g/cc and a melt index of 5.0 g/10 min., a crystallinity of 9 wt % at 23° C. and is commercially available from The Dow Chemical Company, Midland, Mich.

LLDPE is a linear low-density polyethylene having a density of 0.92 g/cc, a melt index of 1.0 g/10 min., total crystallinity of 52 wt %, a crystallinity of 50 wt % at 23° C., a crystallinity of 20 wt % at 110° C., an OIT at 200° C. of 25 minutes and is commercially available from The Dow Chemical Company, Midland, Mich.

1EP(A) is an ethylene-based polymer having a density of 0.931 g/cc, a melt index of 0.70 g/10 min., total crystallinity of 57 wt %, a crystallinity of 56 wt % at 23° C., a crystallinity of 35 wt % at 110° C., an OIT at 200° C. of 123 minutes and is commercially available from The Dow Chemical Company, Midland, Mich.

1EP(B) is an ethylene-based polymer having a density of 0.941 g/cc, a melt index of 0.55 g/10 min., total crystallinity of 66 wt %, a crystallinity of 65 wt % at 23° C., a crystallinity of 50 wt % at 110° C., an OIT at 200° C. of 146 minutes and is commercially available from The Dow Chemical Company, Midland, Mich.

1EP(C) is an ethylene-based polymer having a density of 0.940 g/cc, a melt index of 1.0 g/10 min., total crystallinity of 64 wt %, a crystallinity of 63 wt % at 23° C., a crystallinity of 48 wt % at 110° C., an OIT at 200° C. of 25 minutes and is commercially available from The Dow Chemical Company, Midland, Mich.

MAH-2EP(A) is a maleic anhydride grafted ethylene-based polymer having a density of 0.93 g/cc, a melt index of 1.75 g/10 min. and a maleic anhydride content of 0.9 wt % and is commercially available from The Dow Chemical Company, Midland, Mich.

MAH-2EP(B) is a maleic anhydride grafted ethylene-based polymer having a density of 0.88 g/cc, a melt index of 3.7 g/10 min. and a maleic anhydride content of 0.9 wt % and is commercially available from The Dow Chemical Company, Midland, Mich.

HFFR1 is magnesium hydroxide, an example of which is commercially available under the tradename MAGNIFINTM H-5MV from Huber (Martinswerk GMBH), Bergheim, Germany.

HFFR2 is magnesium hydroxide (brucite) coated with 1.5% fatty acid which is commercially available as Ecopiren 3.5LC from Europiren, Rotterdam, Netherlands.

VA-2EP(A) is an ethylene vinyl acetate copolymer having a vinyl acetate content of 28 wt %, a density of 0.95 g/cc, a melt index of 6.0 g/10 min., total crystallinity of 21 wt %, and is commercially available from The Dow Chemical Company, Midland, Mich.

VA-2EP(B) is an ethylene vinyl acetate copolymer having a vinyl acetate content of 28 wt %, a density of 0.951 g/cc, a melt index of 400 g/10 min., total crystallinity of 21 wt %, and is commercially available from The Dow Chemical Company, Midland, Mich.

Stabilizer MB is a one-pack thermal, process, metal deactivator, aging stabilizer that is commercially available as SILMASTAB™ AX1440 from Silma s.r.l., Italy.

Anti-hydrolysis MB is a master batch used for the stabilization of olfinic polymer compounds commercially available as SILMASTAB™ AX2244 from Silma s.r.l., Italy.

SiMB 1 is a master batch pelletized formulation containing 50 wt % of an ultra-high molecular weight siloxane polymer dispersed in low density polyethylene and is available as silicone MB 50-002 from DuPont, Wilmington, Del.

SiMB2 is a master batch acting as slipping agent, external lubricant and release agent based on polydimethyl siloxane and commercially available as SILMAPROCESS™ AL1142A from Silma s.r.1., Italy.

### Test Methods

Crystallinity Testing: determine melting peaks and percent (%) or weight percent (wt %) crystallinity of ethylene-based polymers at 23° C. or 110° C. using Differential Scanning calorimeter (DSC) instrument DSC Q1000 (TA Instruments). (A) Baseline calibrate DSC instrument. Use software calibration wizard. Obtain a baseline by heating a cell from −80° to 280° C. without any sample in an aluminum DSC pan. Then use sapphire standards as instructed by the calibration wizard. Analyze 1 to 2 milligrams (mg) of a fresh indium sample by heating the standards sample to 180° C., cooling to 120° C. at a cooling rate of 10° C./minute, then keeping the standards sample isothermally at 120° C. for 1 minute, followed by heating the standards sample from 120° C. to 180° C. at a heating rate of 10° C./minute. Determine that indium standards sample has heat of fusion =28.71±0.50 Joules per gram (J/g) and onset of melting=156.6°±0.5° C. (B) Perform DSC measurements on test samples using the baseline calibrated DSC instrument. Press test sample of semi-crystalline ethylene-based polymer into a thin film at a temperature of 160° C. Weigh 5 to 8 mg of test sample film in aluminum DSC pan. Crimp lid on pan to seal pan and ensure closed atmosphere. Place lid-sealed pan in DSC cell, equilibrate cell at 30° C., and then heat at a rate of about 100° C./minute to 190° C., keep sample at 190° C. for 3 minutes, cool sample at a rate of 10° C./minute to −60° C. to obtain a cool curve heat of fusion (H_{f}), and keep isothermally at −60° C. for 3 minutes. Then heat sample again at a rate of 10° C./minute to 190° C. to obtain a second heating curve heat of fusion (ΔH_{f}). Using the second heating curve, calculate the “total” heat of fusion (J/g) by integrating from −20° C. (in the case of ethylene homopolymers, copolymers of ethylene and hydrolysable silane monomers, and ethylene alpha olefin copolymers of density greater than or equal to 0.90g/cc) or −40° C. (in the case of copolymers of ethylene and unsaturated esters, and ethylene alpha olefin copolymers of density less than 0.90g/cc) to end of melting. Using the second heating curve, calculate the “room temperature” heat of fusion (J/g) from 23° C. (room temperature) to end of melting by dropping perpendicular at 23° C. Using the second heating curve, calculate the “110° C.” heat of fusion (J/g) from 110° C. ° C. to end of melting by dropping perpendicular at 110° C. Measure and report “total crystallinity” (computed from “total” heat of fusion) as well as “Crystallinity at room temperature” (computed from 23° C. heat of fusion) and “Crystallinity at 110° C.” (computed from 110° C. heat of fusion). Crystallinity is measured and reported as percent (%) or weight percent (wt %) crystallinity of the polymer from the test sample's second heating curve heat of fusion (ΔH_{f}) and its normalization to the heat of fusion of 100% crystalline polyethylene, where % crystallinity or wt % crystallinity=(ΔH_{f}*100%)/292 J/g, wherein ΔH_{f} is as defined above, * indicates mathematical multiplication, /indicates mathematical division, and 292 J/g is a literature value of heat of fusion (ΔH_{f}) for a 100% crystalline polyethylene.

Hot Knife test is tested according to IEC 60811-508 and is passed by achieving a maximum indentation value of 50% or less after being aged at 110° C. in circulated air for 6 hours.

Tensile elongation at break of the samples was performed in accordance with ASTM D638 on a 5565 tensile testing machine from Instron Calibration Lab using an International Organization for Standards 527 type 5a dog bone.

### Sample Preparation

The polymeric and masterbatch constituents of comparative examples 1 and 2 and of inventive examples 1-4 were prepared as follows. Around 500 grams of each example was produced on a twin-roll mill by first adding the polymer constituents at 160° C. and secondly the additives to form a blend. After melting and homogenization for 3 minutes, the HFFR was added to the blend. After complete incorporation of the filler, the melted compound was left on the rolls for 10 minutes and was removed as a 1 mm thick sheet and cooled down under ambient conditions. Specimens for mechanical property testing were cut directly from the sheet.

Inventive examples 5-10 were mixed by extrusion on a 25 mm, 42 L/D co-rotating twin-screw extruder through a 300 mm flat slit die. The extrudate was then fed into a three roll calender to shape 1 mm thick sheet samples. Samples for mechanical testing were then cut from the sheet.

### Results

Table 1 provides the compositions of comparative examples (“CE”) 1 and CE2 and inventive examples (“IE”) 1-IE10. Table 1 provides tensile elongation at break (“TE”) and the hot knife mechanical performance data for each example.

TABLE 1

| | CE1 | CE2 | IE1 | IE2 | IE3 | IE4 | IE5 | IE6 | IE7 | IE8 | IE9 | IE10 |
|---|---|---|---|---|---|---|---|---|---|---|---|---|
| Material (wt %) | | | | | | | | | | | | |
| 2EP(A) | 15 | 13.5 | 15 | 13.5 | 15 | 13.5 | 0 | 0 | 0 | 0 | 0 | 0 |
| 2EP(B) | 0 | 0 | 0 | 0 | 0 | 0 | 5.5 | 5.5 | 10 | 10 | 10 | 10 |
| LLDPE | 29.5 | 26 | 0 | 0 | 0 | 0 | 0 | 0 | 0 | 0 | 0 | 0 |
| 1EP(A) | 0 | 0 | 29.5 | 26 | 0 | 0 | 0 | 0 | 0 | 0 | 8 | 0 |
| 1EP(B) | 0 | 0 | 0 | 0 | 29.5 | 26 | 0 | 10 | 0 | 8 | 0 | 8 |
| 1EP(C) | 0 | 0 | 0 | 0 | 0 | 0 | 10 | 0 | 8 | 0 | 0 | 0 |
| MAH-2EP(A) | 0 | 0 | 0 | 0 | 0 | 0 | 5 | 5 | 5 | 5 | 5 | 0 |
| MAH-2EP(B) | 0 | 0 | 0 | 0 | 0 | 0 | 0 | 0 | 0 | 0 | 0 | 5 |
| HFFR1 | 0 | 0 | 0 | 0 | 0 | 0 | 63 | 63 | 60 | 60 | 60 | 60 |
| HFFR2 | 50 | 55 | 50 | 55 | 50 | 55 | 0 | 0 | 0 | 0 | 0 | 0 |
| VA-2EP(A) | 0 | 0 | 0 | 0 | 0 | 0 | 16 | 16 | 15 | 15 | 15 | 15 |
| VA-2EP(B) | 3 | 3 | 3 | 3 | 3 | 3 | 0 | 0 | 0 | 0 | 0 | 0 |
| Stabilizer MB | 1 | 1 | 1 | 1 | 1 | 1 | 0 | 0 | 0 | 0 | 0 | 0 |
| Anti-hydrolysis MB | 0.5 | 0.5 | 0.5 | 0.5 | 0.5 | 0.5 | 0 | 0 | 0 | 0 | 0 | 0 |
| SiMB1 | 0 | 0 | 0 | 0 | 0 | 0 | 0.5 | 0.5 | 2 | 2 | 2 | 2 |
| SiMB2 | 1 | 1 | 1 | 1 | 1 | 1 | 0 | 0 | 0 | 0 | 0 | 0 |
| TOTAL | 100 | 100 | 100 | 100 | 100 | 100 | 100 | 100 | 100 | 100 | 100 | 100 |
| Mechanical Properties | | | | | | | | | | | | |
| Hot Knife | 75% | 75% | 20% | 20% | 10% | 10% | 32% | 1% | 10% | 20% | 23% | 40% |
| TE | 610% | 600% | 531% | 567% | 498% | 525% | 142% | 125% | 200% | 200% | 250% | 200% |

As can be seen from Table 1, CE1 and CE2 do not comprise the first ethylene-based polymer (i.e., having a crystallinity at 110° C. of 25 wt % or greater) and therefore are unable to meet the hot knife performance requirement. While the crystallinity of the 2EP(A) or LLDPE is sufficiently low to allow incorporation of the HFFR and meet the TE requirement, the crystallinity at 110° C. is too low to pass the hot knife test. IE1-IE10 are all able to meet the TE and hot knife requirements through the incorporation of the first ethylene-based polymer (i.e., ethylene-based polymers having a crystallinity at 110° C. of 25 wt % or greater). IE1-IE10 demonstrate that the use ethylene-based polymers having crystallinities at 110° C. of 35 wt % or greater allow the passing of the TE and hot knife requirements. It is believed that the incorporation of ethylene-based polymers having a crystallinity at 110° C. of as low as 25 wt % would allow the polymeric composition to pass the TE and hot knife requirements. IE1-IE10 also demonstrate that a wide range (i.e., from 8 wt % to about 30 wt %) of the first ethylene-based polymer may be used in the polymeric composition and still achieve the TE and hot knife mechanical properties. It is believed that using from 5 wt % to 40 wt % of the first ethylene-based polymer would allow the polymeric composition to achieve the TE and hot knife mechanical properties. It is also believed the increased or satisfactory OIT at 200° C. for 1EP(A), 1EP(B) and 1EP(C) beneficially resists degradation of the sample's modulus after heat exposure thereby allowing better performance in the hot knife test.

1. A polymeric composition comprising:
a first ethylene-based polymer having a crystallinity at 110° C. of 25 wt % or greater as measured according to Crystallinity Testing;
a second ethylene-based polymer having a crystallinity at 23° C. of 40 wt % or less as measured according to Crystallinity Testing; and
40 wt % or greater of a halogen-free flame retardant filler.

2. The polymeric composition of claim 1, wherein the halogen-free flame retardant filler is magnesium hydroxide.

3. The polymeric composition of claim 2, wherein the polymeric composition comprises from 40 wt % to 65 wt % of magnesium hydroxide based on the total weight of the polymeric composition.

4. The polymeric composition of claim 1, wherein the polymeric composition comprises from 5 wt % to 40 wt % of the second ethylene-based polymer based on the total weight of the polymeric composition.

5. The polymeric composition of claim 1, wherein the polymeric composition comprises from 5 wt % to 40 wt % of the first ethylene-based polymer based on the total weight of the polymeric composition.

6. The polymeric composition of claim 5, wherein the first ethylene-based polymer has a density of 0.925 g/cc to 0.950 g/cc.

7. The polymeric composition of claim 6, wherein the first ethylene-based polymer comprises a low-density component having a density in the range from 0.910 g/cc to 0.935 g/cc as measured according to ASTM D792.

8. The polymeric composition of claim 7, wherein the first ethylene-based polymer comprises a high-density component having a density in the range from 0.945 g/cc to 0.965 g/cc as measured according to ASTM D792.

9. The polymeric composition of claim 1, wherein the first ethylene-based polymer has an Oxidative Induction Time at 200° C. of 20 minutes or greater as measured according to ASTM D3895.

10. A coated conductor comprising:
a conductor; and
the polymeric composition of claim 1 disposed at least partially around the conductor.
